(19) United States
(12) Patent Application Publication
(10) Pub. No.: US 2008/0067250 A1
(43) Pub. Date: Mar. 20, 2008

(54) Imaging reader and method with optically modified field of view

(76) Inventor: Igor Vinogradov, Bay Shore, NY (US)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/523,237

(22) Filed: Sep. 19, 2006

(51) Int. Cl. G06K 7/10

(52) U.S. Cl. 235/462.24; 235/462.41

(57) ABSTRACT

A target is illuminated with light for image capture by a solid-state imager and an imaging lens of an imaging reader over a wide field of view which is narrowed by a curved folding mirror that enables far-out and close-in targets to be imaged and read.

### DESCRIPTION OF THE RELATED ART

Flat bed laser readers, also known as horizontal slot scanners, have been used to electro-optically read one-dimensional bar code symbols, particularly of the Universal Product Code (UPC) type, at a point-of-transaction workstation in supermarkets, warehouse clubs, department stores, and other kinds of retailers for many years. As exemplified by U.S. Pat. No. 5,059,779; No. 5,124,539; and No. 5,200,599, a single, horizontal window is set flush with, and built into, a horizontal countertop of the workstation. Products to be purchased bear an identifying symbol and are typically slid or swiped across the horizontal window through which a multitude of scan lines is projected in a generally upwards direction. When at least one of the scan lines sweeps over a symbol associated with a product, the symbol is processed and read.

The multitude of scan lines is generated by a scan pattern generator which includes a laser for emitting a laser beam at a mirrored component mounted on a shaft for rotation by a motor about an axis. A plurality of stationary mirrors is arranged about the axis. As the mirrored component turns, the laser beam is successively reflected onto the stationary mirrors for reflection therefrom through the horizontal window as a scan pattern of the scan lines.

Instead of, or in addition to, a horizontal slot scanner, it is known to provide a vertical slot scanner, which is typically a portable reader placed on the countertop such that its window is generally vertical and faces an operator at the workstation. The generally vertical window is oriented perpendicularly to the horizontal window, or is slightly rearwardly inclined. The scan pattern generator within the workstation also projects the multitude of scan lines in a generally outward direction through the vertical window toward the operator. The generator for the vertical window can be the same as or different from the generator for the horizontal window. The operator slides or swipes the products past either window from right to left, or from left to right, in a “swipe” mode. Alternatively, the operator merely presents the symbol on the product to the center of either window in a “presentation” mode. The choice depends on operator preference or on the layout of the workstation.

Each product must be oriented by the operator with the symbol facing away from the operator and directly towards either window. Hence, the operator cannot see exactly where the symbol is during scanning. In typical “blind-aiming” usage, it is not uncommon for the operator to repeatedly swipe or present a single symbol several times before the symbol is successfully read, thereby slowing down transaction processing and reducing productivity.

The blind-aiming of the symbol is made more difficult because the position and orientation of the symbol are variable. The symbol may be located low or high, or right or left, on the product, or anywhere in between. The symbol may be oriented in a “picket fence” orientation in which the elongated parallel bars of the one-dimensional UPC symbol are vertical, or in a “ladder” orientation in which the symbol bars are horizontal, or at any orientation angle in between.

These point-of-transaction workstations have been used for processing transactions involving products associated with one-dimensional symbols each having a row of bars and spaces spaced apart along one direction, and also for processing two-dimensional symbols, such as Code 49, as well. Code 49 introduced the concept of vertically stacking a plurality of rows of bar and space patterns in a single symbol. The structure of Code 49 is described in U.S. Pat. No. 4,794,239. Another two-dimensional code structure for increasing the amount of data that can be represented or stored on a given amount of surface area is known as PDF417 and is described in U.S. Pat. No. 5,304,786. Such two-dimensional symbols are generally read by electro-optical readers operative for projecting a laser beam as a raster of scan lines, each line extending in one direction over a respective row, and all the lines being spaced apart along a height of the two-dimensional symbol in a generally perpendicular direction.

Both one- and two-dimensional symbols can also be read by employing solid-state imagers. For example, an image sensor device may be employed which has a one- or two-dimensional array of cells or photosensors, which correspond to image elements or pixels in a field of view of the device. Such an image sensor device may include a one- or two-dimensional charge coupled device (CCD) or a complementary metal oxide semiconductor (CMOS) device and associated circuits for producing electronic signals corresponding to a one- or two-dimensional array of pixel information over a field of view. In addition to the aforementioned symbols, scanners employing image sensor devices can also read general two-dimensional symbols, such as DataMatrix, which cannot be read by existing laser-based scanners.

It is therefore known to use a solid-state device for capturing a monochrome image of a symbol as, for example, disclosed in U.S. Pat. No. 5,703,349. It is also known to use a solid-state device with multiple buried channels for capturing a full color image of a target as, for example, disclosed in U.S. Patent No. 4,613,895. It is common to provide a two-dimensional CCD with a 640×480 resolution commonly found in VGA monitors, although other resolution sizes are possible.

Thus, the known point-of-transaction portable readers utilize solid-state imagers for capturing images of one- or two-dimensional targets, especially one- or two-dimensional symbols required to be electro-optically read, over a field of view that diverges in an outward direction away from the imager and the window. The products bearing the symbols are typically positioned in physical contact with, or closely adjacent to, the window in order to enable the reader to read such close-in symbols. When the products are too heavy, or too large, or too bulky, to be brought to the window, then the portable reader itself is lifted from the countertop, and its window is aimed at such far-out symbols to enable the reader to read them at a distance from the window.

Although generally satisfactory for their intended purpose, the diverging field of view of imaging readers must be large enough to cover the close-in symbols and small enough to enable the far-out symbols to be read. If the field of view at the close-in symbols is too small, then the reader may be unable to entirely cover and read the close-in symbols. If the field of view at the far-out symbols is too large, then the number of pixels available for each bar and space element of the symbol may be too few to enable the reader to reliably read the far-out symbols.

### SUMMARY OF THE INVENTION

One feature of the present invention resides, briefly stated, in a reader for, and a method of, electro-optically reading a target, especially one-dimensional symbols, two-dimensional symbols, or documents. The reader is preferably embodied as a portable point-of-transaction box-shaped housing having a window, but could be embodied as a gun-shaped handheld housing having a window. During reading of close-in targets brought to the reader, the target may be swiped past the window, or may be presented closely adjacent to, or preferably in contact with, the window of the reader. During reading of far-out targets, the reader is brought to, or the window is aimed at, the far-out targets. In the preferred embodiment, the reader is installed in a retail establishment, such as a supermarket, but can be installed virtually anywhere requiring targets to be read.

The window is preferably a sheet of light-transmissive plastic or glass, and its primary function is to keep dust and like contaminants out of the housing. The window need not be positioned at a front or nose of the housing, but may be deeply recessed within the housing well away from the nose to minimize reflections at the window, thereby leaving a bare opening or aperture at the nose of the housing. The window need not be in a vertical plane, but can be oriented at any angle relative to the nose of the housing. In some applications, the window itself may be eliminated. For these reasons, the place where light from the target enters the housing is sometimes referred to herein as a “scanning aperture” or as a “presentation area”.

A one- or two-dimensional, solid-state imager is mounted in the reader, and includes an array of image sensors operative for capturing light from a one-dimensional and/or a two-dimensional target passing through the presentation area over a field of view during the reading. Preferably, the array is a CCD array, but could be a CMOS array. An imaging lens is mounted in the reader in front of the imager to focus the captured light onto the imager. The imager may be associated with a high-speed strobe illuminator under control of a controller to enable the image of the target to be acquired in a very short period of time, for example, on the order of 500 microseconds, so that the target image is not blurred even if there is relative motion between the imager and the target. The strobe illumination is preferably brighter than ambient illumination, especially close to the presentation area. The illumination can also be continuous. The imager captures light over an exposure time period, also under the control of the controller. A short exposure time also prevents image blurring.

The field of view of the imager diverges in an outward direction away from the imager. The imager is mounted in the housing at a distance well away from the presentation area and sufficient to enable the diverging field of view to substantially cover the presentation area and a close-in target presented closely adjacent to, or in contact with, the presentation area. Preferably, the imaging lens widens the diverging field of view to insure that the entire close-in target is covered. The imaging lens causes the field of view to rapidly widen at a steep angle of divergence.

As noted above, the rapidly widening field of view may become too large for far-out targets to be read. In accordance with this invention, an optical element is provided in the housing for optically modifying and narrowing the field of view to enable the far-out targets at far-out working distances from the presentation area to be read. The optical element is preferably a concavely curved folding mirror and is located between front and rear walls of the housing. The imager and the imaging lens face the concavely curved folding mirror and capture and focus the optically modified light reflected by the concavely curved folding mirror. The concavely curved folding mirror decreases the steep divergence angle between itself and the target. The optically modified field of view is still wide enough to cover the close-in targets and is narrow enough to enable the far-out targets to be reliably read. Preferably, the concavely curved folding mirror has a parabolic configuration.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a point-of-transaction workstation operative for capturing light from targets in accordance with the prior art;

FIG. 2 is a schematic block diagram of various components of an imaging reader used in the workstation of FIG. I in accordance with the prior art; and

FIG. 3 is a practical implementation of an imaging reader in accordance with the present invention.

### DETAILED DESCRIPTION OF THE PREFERRED EMBODIMENTS

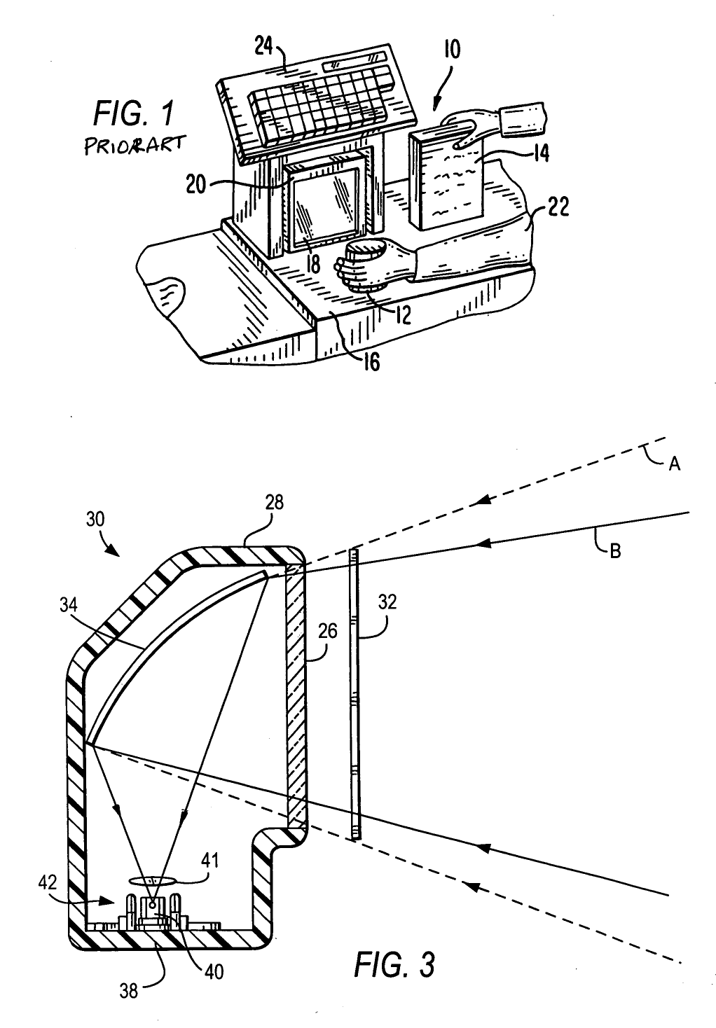

Reference numeral 10 in FIG. 1 generally identifies a workstation in accordance with the prior art for processing transactions and specifically a checkout counter at a retail site at which products, such as a can 12 or a box 14, each bearing a target symbol, are processed for purchase. The counter includes a countertop 16 across which the products are slid at a swipe speed past a vertical window 18 of a box-shaped vertical slot reader 20 mounted on the countertop 16. A checkout clerk or operator 22 is located at one side of the countertop, and the reader 20 is located at the opposite side. A cash/credit register 24 is located within easy reach of the operator. The operator 22 may also position the products in contact with the window 18. In the event that the products are too heavy, too bulky, or too large to be brought to the window, then the operator may lift the reader 20 off the countertop, and aim the window at the target symbol on the product which is located well away from the window.

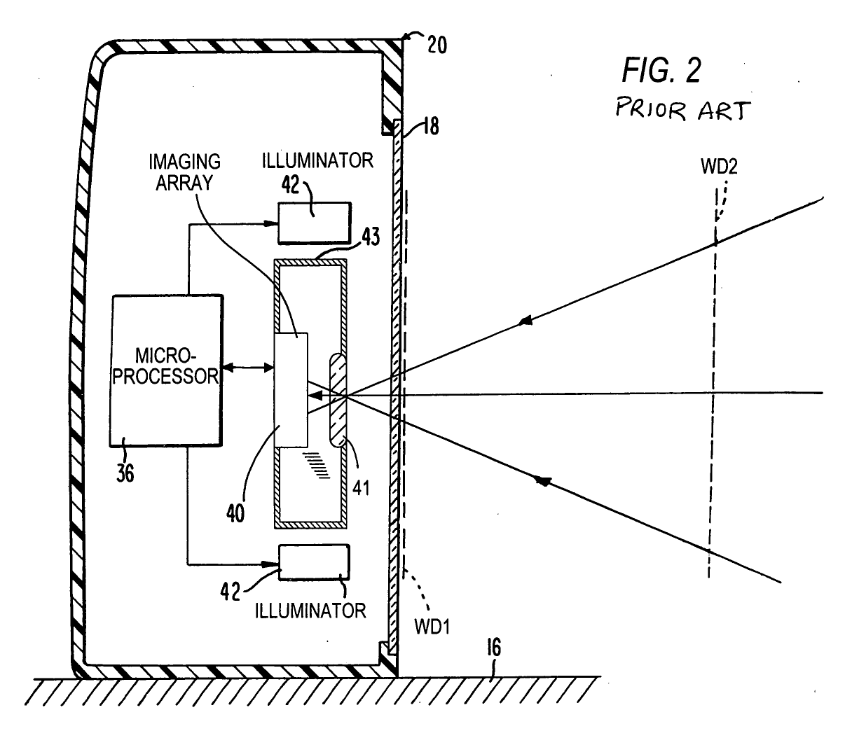

As shown in FIG. 2, in further accordance with the prior art, the vertical slot scanner generally includes an imager 40 and a focusing imaging lens 41 mounted in an enclosure 43. The imager 40 is a solid-state device, for example, a CCD or a CMOS imager and has an array of addressable image sensors operative for capturing light through the window 18 from a target over a field of view and located in a working range of distances between a close-in working distance (WD1) and a far-out working distance (WD2). Typically, WD1 is about two inches from the imager array 40 and generally coincides with the window 18, and WD2 is about eight inches from the window 18. In some applications, the window itself may be eliminated. For these reasons, the place where light from the target enters the housing is sometimes referred to herein as a “scanning aperture” or as a “presentation area”. An illuminator 42 is also mounted in the reader and preferably includes a plurality of light sources, e.g., light emitting diodes (LEDs), arranged around the imager 40 to uniformly illuminate the target.

As also shown in FIG. 2, the imager 40 and the illuminator 42 are operatively connected to a controller or microprocessor 36 operative for controlling the operation of these components. Preferably, the microprocessor is the same as the one used for decoding light scattered from the target symbol and for processing the captured target images.

In operation, the microprocessor 36 sends a command signal to the illuminator 42 to pulse the LEDs for a short time period of 500 microseconds or less, and energizes the imager 40 to collect light from a target substantially only during said time period. A typical array needs about 33 milliseconds to read the entire target image and operates at a frame rate of about 30 frames per second. The array may have on the order of one million addressable image sensors.

As shown in FIG. 3, the solid-state imager 40 is mounted within a housing 28 of a reader 30 in which a window (or presentation area) 26 is supported to capture light from a target 32, e.g., a one-dimensional symbol, a two-dimensional symbol, a document, etc. over a field of view “A”, as shown in dashed lines, that diverges in an outward direction away from the presentation area and the imager. The imaging lens 41 is operative for focusing the captured light onto the imager. The housing has a base 38 on which the imager 40 and the imaging lens 41 are supported, together with the illuminator 42.

Positioning the imager 40 deep within the housing enables the diverging field of view to fully cover the target and the presentation area. This enables close-in targets within the working distance WD1 to be read. Positioning the illuminator 42 deep within the housing enables a more uniform illumination of the target, especially up close to the presentation area 26. Another way of achieving a full coverage of the target and the presentation area is to insure that the imaging lens 41 has a wide field of view.

However, the imaging lens 41 causes the field of view to rapidly widen at a steep angle of divergence relative to the horizontal. As noted above, the rapidly widening field of view may become too large for far-out targets to be read. In accordance with this invention, an optical element 34 is provided in the housing for optically modifying and narrowing the wide field of view “A” to a narrow field of view “B” shown in solid lines in FIG. 3, to enable the far-out targets at far-out working distances WD2 from the presentation area to be read. The optical element 34 is preferably a concavely curved folding mirror and is located between front and rear walls of the housing. The imager 40 and the imaging lens 41 face the concavely curved folding mirror 34 and capture and focus the optically modified light reflected by the concavely curved folding mirror 34. The concavely curved folding mirror 34 decreases the steep divergence angle between itself and the target 32. The optically modified field of view B is still wide enough to cover the close-in targets and is narrow enough to enable the far-out targets to be read. Preferably, the concavely curved folding mirror 34 has a parabolic configuration, but can also have an aspherical or a conical configuration.

In accordance with this invention, the folding mirror 34 allows the front-to-back dimension of the housing 28 to be reduced. This minimizes the size of the reader footprint, which is often important in crowded work environments such a retail point-of-sale workstation.

To minimize image blurring, the controller controls how long the LEDs will be energized, whether the energization is continuous or pulsed, the duty cycle of the LEDs, and the intensity of the illumination. In addition, the controller controls the exposure time period of the sensors of the array. The shorter the exposure time period, and the shorter and brighter the illumination of the illuminator, the less likely there will be image blurring even if there is relative motion between the target and the window during reading.

It will be understood that each of the elements described above, or two or more together, also may find a useful application in other types of constructions differing from the types described above. Thus, readers having different configurations can be used.

While the invention has been illustrated and described as optically modifying a field of view in an imaging reader, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

1. A reader for electro-optically reading targets located in a range of working distances from the reader, comprising:
a) a housing having a target presentation area;
b) a solid-state imager including an array of image sensors and an imaging lens for capturing and focusing light through the presentation area from each target over a field of view, the imager and the imaging lens being positioned within the housing for a distance sufficient to enable the field of view to substantially cover the entire presentation area to enable close-in targets at close working distances from the presentation area to be read; and
c) an optical element in the housing for optically modifying and narrowing the field of view to enable far-out targets at far-out working distances from the presentation area to be read.

2. The reader of claim 1, wherein the housing has a base for supporting the reader on a generally planar support surface, and wherein the imager and the imaging lens are mounted on the base.

3. The reader of claim 1, wherein the presentation area lies in a generally vertical plane; and a generally planar light-transmissive window mounted on the housing and extending generally parallel to the vertical plane of the presentation area.

4. The reader of claim 1; and an illuminator for illuminating the targets with illumination light, and wherein the illuminator is recessed within the housing for a distance sufficient to enable the illumination light to uniformly illuminate the targets.

5. The reader of claim 4, wherein the illuminator includes a plurality of light emitting diodes (LEDs).

6. The reader of claim 1, wherein the optical element is a concavely curved folding mirror between front and rear walls of the housing, and wherein the imager and the imaging lens face the concavely curved folding mirror to capture and focus optically modified light reflected by the concavely curved folding mirror.

7. The reader of claim 6, wherein the field of view diverges at a divergence angle in an outward direction away from the imager and the presentation area, and wherein the concavely curved folding mirror decreases the divergence angle between itself and the targets.

8. The reader of claim 6, wherein the concavely curved folding mirror has a parabolic configuration.

9. The reader of claim 1, wherein each target is at least one selected from a group including a one-dimensional symbol, a two-dimensional symbol, and a document.

10. The reader of claim 1, wherein the imager is one of a charge coupled device and a complementary metal oxide silicon device.

11. A reader for electro-optically reading targets located in a range of working distances from the reader, comprising:
a) housing means having a target presentation area;
b) solid-state imager means including an array of image sensors and an imaging lens for capturing and focusing light through the presentation area from each target over a field of view, the imager and the imaging lens being positioned within the housing means for a distance sufficient to enable the field of view to substantially cover the entire presentation area to enable close-in targets at close working distances from the presentation area to be read; and
c) optical means in the housing means for optically modifying and narrowing the field of view to enable far-out targets at far-out working distances from the presentation area to be read.

12. A method of electro-optically reading targets located in a range of working distances, comprising the steps of:
a) positioning a target presentation area on a housing of an electro-optical reader;
b) capturing and focusing light with an array of image sensors of a solid-state imager and an imaging lens through the presentation area from the targets over a field of view;
c) positioning the array and the imaging lens within the housing for a distance sufficient to enable the field of view to substantially cover the entire presentation area to enable close-in targets at close working distances from the presentation area to be read; and
d) optically modifying and narrowing the field of view to enable far-out targets at far-out working distances from the presentation area to be read.

13. The method of claim 12, and supporting the reader with a base on a generally planar support surface, and mounting the imager and the imaging lens on the base.

14. The method of claim 12, and configuring the presentation area to lie in a generally vertical plane; and mounting a generally planar light-transmissive window on the housing and positioning the window to lie generally parallel to the vertical plane of the presentation area.

15. The method of claim 12; and illuminating the targets with illumination light from an illuminator, and recessing the illuminator within the housing for a distance sufficient to enable the illumination light to uniformly illuminate the targets.

16. The method of claim 12, wherein the optically modifying step is performed by a concavely curved folding mirror positioned between front and rear walls of the housing, and facing the imager and the imaging lens toward the concavely curved folding mirror to capture and focus optically modified light reflected by the concavely curved folding mirror.

17. The method of claim 16, wherein the field of view diverges at a divergence angle in an outward direction away from the imager and the presentation area, and wherein the concavely curved folding mirror decreases the divergence angle between itself and the targets.

18. The method of claim 16, and shaping the concavely curved folding mirror with a parabolic configuration.

19. The method of claim 12; and the step of selecting the targets from a group including a one-dimensional symbol, a two-dimensional symbol, and a document.

20. The method of claim 12; and the step of selecting the imager from one of a charge coupled device and a complementary metal oxide silicon device.
